(19) United States
(12) Patent Application Publication
(10) Pub. No.: US 2018/0027786 A1
(43) Pub. Date: Feb. 1, 2018

(54) Fishing Lure and Related Methods

(71) Applicant: Marshal David Baggett, Lake Charles, LA (US)

(72) Inventor: Marshal David Baggett, Lake Charles, LA (US)

(21) Appl. No.: 15/221,574

(22) Filed: Jul. 27, 2016

(51) Int. Cl. A01K 85/00

(52) U.S. Cl. CPC A01K 85/00

(57) ABSTRACT

This invention references a product and related methods for transforming a common soft body fishing lure into a materially different lure. By adding the buoyancy invention and one or more related components in the prescribed manner, the flotation, appearance, and movement of a soft body lure is changed to a completely different fishing presentation and application. The invention and related methods are not limited to a single common soft body lure shape but can also be used with custom soft body lures specifically designed to attach to the invention.

### BACKGROUND OF INVENTION

The present invention provides a facile method of incorporating a buoyancy control device (the invention) and related components to a soft body fishing lure typically made of rubber, silicone, plastic, or elastic in such a way that the separate pieces can become one lure. The attached buoyancy device, composed of a material such as, but not limited to. Styrofoam, cork, or wood, is constructed with a different density and buoyancy than the portion of lure that it is attached to, thereby entirely changing the flotation and dynamic motions of the common soft body lure. The various colors and shapes of the invention will add different appearances, movements, and flotation to most soft body iures.

Thus, in one embodiment of this invention, there is provided a simple, effective method of transforming an otherwise sinking lure into a floating lure. Therefore, the Invention changes the buoyancy of the existing lure from a subsurface lure to a top water lure.

In another embodiment of this invention, as a floating fishing lure, the soft body lure can now produce various types of actions depending upon the construction contours of the selected buoyancy device attached. For example, one buoyancy device may be constructed to produce a popping effect, another may have a darting effect, and another may have a diving effect, and yet another device may be constructed to create a jumping effect. Each effect can be chosen at the angler's discretion based upon the buoyancy device selected.

In still another embodiment of this invention is a method for keeping the lure from sinking and dragging on the bottom. Many elastic lures such as the common piastic worms, trail behind a weight that is fixed 18 inches to 24 Inches ahead of the bait which brings the lure to the bottom along with the weight. This is commonly known as the “Carolina Rig”. Many anglers desire that only the weight stay on the bottom and the lure stay off of the bottom, but unfortunately the weight of the hook in the lure combined with the weighr of the lure itself causes the lure to sink to the bottom also. However, with this invention and related system fastened to the lure, the buoyancy of the bait will be altered allowing it to rise above the bottom, thus increasing the angler's potential catch of fish. The angler can now choose the desired height the lure can rise above the bottom.

### BRIEF DESCRIPTION OF DRAWINGS

FIG. 1 is a representation of a prior art of a common soft body fishing lure.

FIG. 2 is a side view of the invention and related system as separate components.

FIG. 3 is a side view of the invention and related system joined together as a single component.

FIG. 4 is a bottom view of the separate components of the preferred soft body lure and related system.

FIG. 5 is a side view of the common soft lure as it relates to being suspended between the surface and bottom of the water.

FIG. 6 is a side view that illustrates how the preferred soft lure embodiment and related system is joined together as a single component and would reside in the water at rest.

FIG. 7 is a side view representation of a weighted, prior art common soft body fishing lure known as the “Carolina Rig”.

FIG. 8 is a side view representation of a new presentation of a weighted, soft body lure with the preferred embodiment fished as the “Carolina Rig”.

FIG. 9 is a side view of the preferred embodiment illustrating a typical surface movement that the preferred embodiment is capable of preforming.

FIG. 10 is a side view of the preferred embodiment illustrating a diving lip fabricated as part of the buoyancy device which will enable the new embodiment to dive subsurface thus creating a swimming effect.

FIG. 11 is a bottom view representation of the buoyancy device invention illustrating the stopper port and the hook slot relief channel in the cavity of the buoyancy device and some related anatomy.

FIG. 12 is a side view of the buoyancy device invention illustrating the relationship of how the common hook will relate to the hook slot channel of the buoyancy device in the casting position.

FIG. 13 is a side view of the buoyancy device invention illustrating the ability for the common hook to freely move inside the hook relief channel when a fish is attached.

### DETAILED DESCRIPTION OF THE INVENTION

As will now be appreciated in the drawing details, the present invention, along with the related system of components, when attached to a common soft bodied fishing lure or a custom made soft body lure, will transform the dynamics of an existing lure into a new and materially different embodiment. By completely changing the movement, buoyancy, shape and appearance of the common soft body lure, the new embodiment will possess a more lifelike color and character, thus changing the perception from one of artificial into a more realistic appearance and application.

FIG. 1 is an illustration of a common soft body lure (12) prepared with the fishing line (10) and hook (14). The pictorial is not an exclusive indication of all soft body lures to which the invention can be applied, but rather a related sample for illustrative and comparative purposes only. The principle of the invention is applied to all soft body lures including, but not limited to, worms, frogs, and flukes. Some applications of the soft body lure will have the hook hidden inside of the lure while other applications will have the hook exposed. The invention and related system will apply to either. However, for ease of understanding the illustrations will only show the hook hidden in the lure commonly called a fluke.

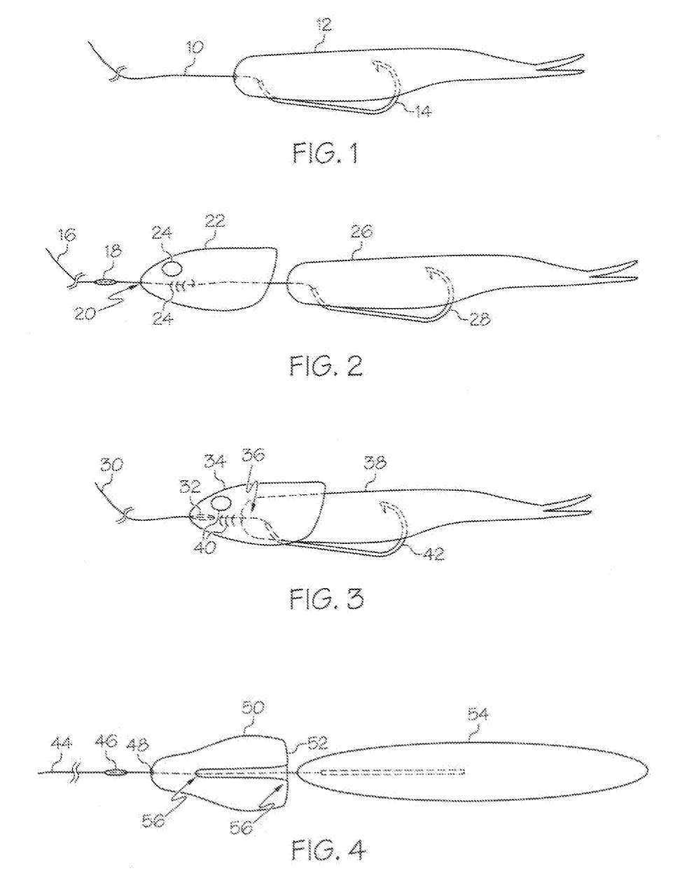

The fishing lure invention and related system embodiment components are illustrated in FIG. 2 containing five basic parts; the soft body fishing lure (26), the hook (28), the line (16), the rubber stopper (18), and the buoyancy device invention (22), pictured as the head of the fishing lure. The buoyancy device contains an anterior receptacle port (20) to receive the stopper. The application of the line stopper can be separate as illustrated in this pictorial or manufactured as part of the buoyancy device. Some replicated fish anatomy is illustrated (40) however, it is not conclusive of all anatomical parts but has been limited so as not to over crowd the pictorial. Other anatomical parts include, but not limited to, eyes, scales, fins, gills, mouth, and nostrils.

As illustrated in FIG. 3 the buoyancy device and the related system components are connected together forming one complete embodiment. The rubber stopper (32), through which the line passes, is now embedded inside of the buoyancy device port and will firmly hold the embodiment together as well as, create a virtually snag free fishing lure for soft body lures with a hidden hook. Also illustrated in FIG. 3, is the insertion of the anterior portion of the soft body fishing lure into the hollow cavity at the rear of invented buoyancy device (36). Such incorporation will give the existing common soft fishing lure a totally new action and cosmetic appearance as compared to FIG. 1. It should be noted here, but will be explained in more detail later, that the hook shaft exits the soft body lure anteriorly in the hook slot relief channel of the buoyancy device and reenters the soft body lure again posteriorly as pictured. As the hook exits the lure anteriorly in the hook slot, it will be confined to the channel and this will prevent the soft body lure from twisting in the buoyancy device and help prevent the lure from flipping as it is retrieved.

FIG. 4 is a bottom (ventral) view of the fishing lure invention and related system embodiment components. In this view one can see how the fishing line (44) will pass through the stopper (46) and slide into the buoyancy device port (48). This pictorial also illustrates one of the many shapes and contours of the buoyancy device (50) and the unique hook slot channel (56) of the buoyancy device. This buoyancy device is not limited to the shape illustrated but can be contoured to give the soft body lure embodiment (54) a popping action, a sliding action, a darting action, a jumping action, and/or a diving action.

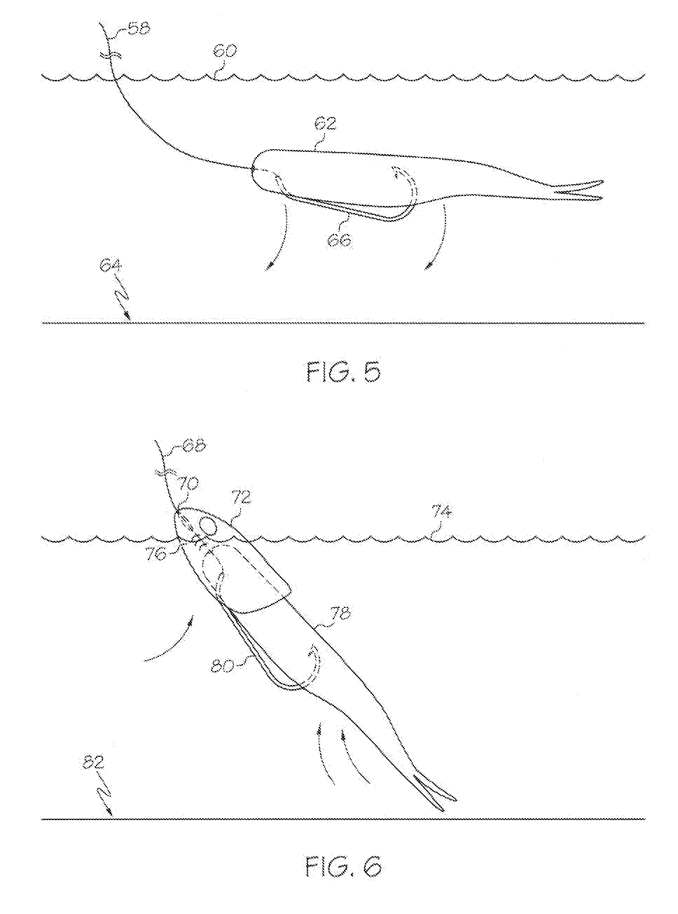

FIG. 5 illustrates the relationship of the common soft body lure (62) to the top (60) and bottom (64) of the water as being presented by an anger while fishing. It should be noted that the common soft body lure will slowly sink on its own accord to the bottom due to the weight of the hook (66) combined with the actual lure weight (62). Therefore, the lure is only elevated or moves when the angler tightens the line (58) upon retrieval. However, as illustrated in FIG. 6, using the buoyancy device (72) and related system will totally transform the common soft body fishing lure (78) into a much different type of embodiment. By attaching the buoyancy device and related system the same common soft body fishing lure it will now float and stand more upright of its own accord. It is now capable of maintaining a surface position without any tension on the fishing line (68). Further, any wind or waves on the surface (74) will actually give the preferred embodiment motion even without the anger tightening the fishing line thus giving the lure a more realistic presentation. As further seen by the direction of the arrows in FIG. 6, any jerking or tension on the line from the angler will cause the preferred embodiment to rise and become more horizontal in the water upon retrieval. Once the tension is relieved then the preferred embodiment will go back to a more vertical position. This type of application will allow the lure to freely move when the line tension has dissipated. This type of action has been known to help solicit a fish to strike.

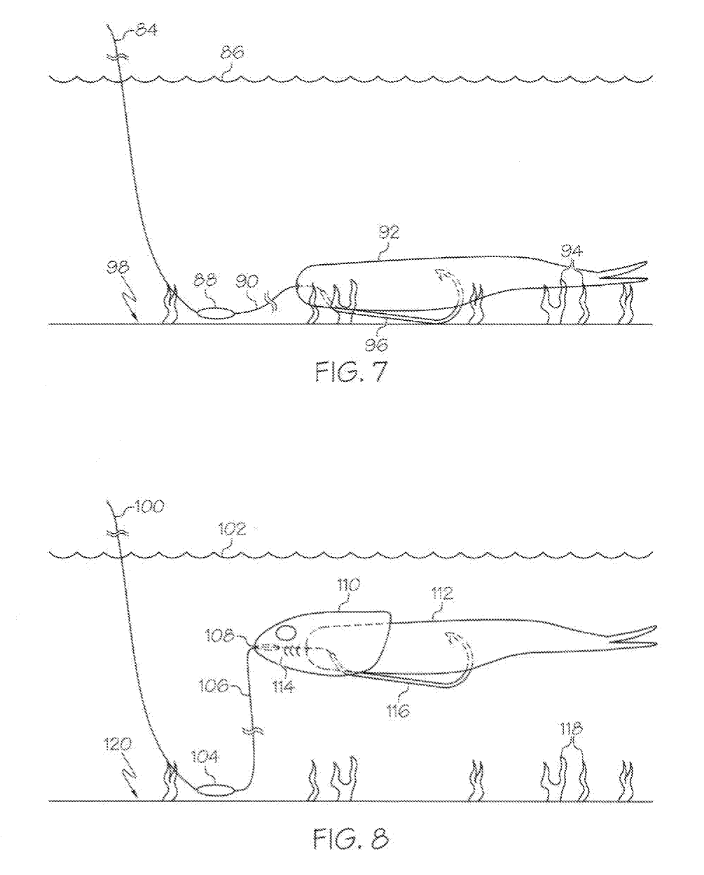

FIG. 7 illustrates a prior art of a common fishing lure known as “the Carolina Rig”. As understood in the pictorial, a weight (88) is fastened approximately 18 inches ahead (90) of soft body lure (92). As the angler drags the weight across the bottom or through underwater structure (94) the lure will follow behind and will also slowly sink to the bottom as it is pulled. However, as illustrated in FIG. 8, with the incorporation of the buoyancy device invention (110) and related system, the prior art is converted from a bottom lure to a suspended lure at the discretion of the angler. Such change will allow the new embodiment to rise above the bottom (120) and many underwater obstructions (118) thereby causing the lure to be more efficiently snag resistant, while providing a better lure presentation, and thereby keeping the lure in the fish's strike zone longer. The amount of rise is determined by the length of line (106) that the angler allows between the lure and the weight. As now can be seen, the hook (116) in the preferred embodiment is no longer dragging the bottom (120) where most obstructions exist. It can also be appreciated in this illustration that the embedded stopper (108) will hold all of the components in their proper position thereby aiding the angler's defense in avoiding the lure getting hung up on obstructions.

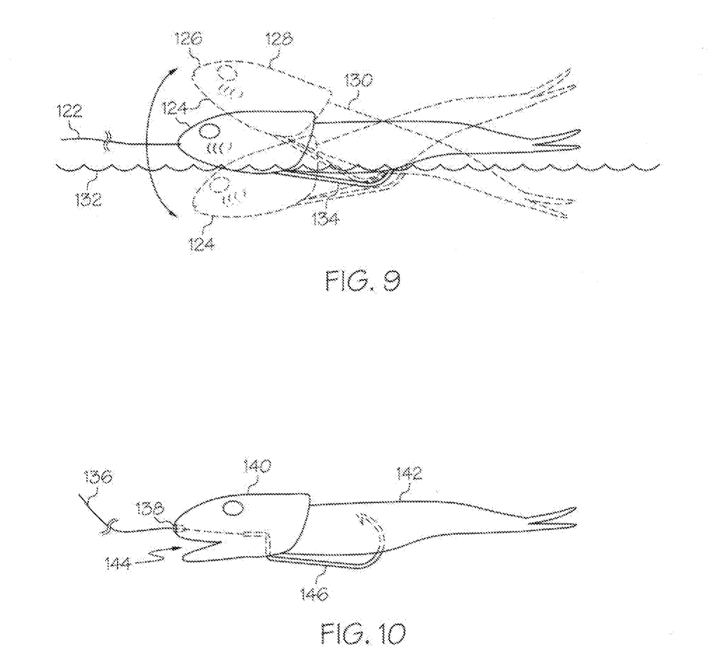

As previously illustrated in FIG. 5, the common soft body lure typically moves in one basic straight direction upon retrieval and once retrieval has ceased then lure begins to sink. By comparison, as noted in FIG. 9, incorporating the buoyancy device (128) and related system into the same common soft body lure (130) will now enable it to float and move in multiple directions (124), mainly side to side, at the surface of the water (132) and will remain floating even when the angler releases tension of the fishing line (122). Such dynamic action greatly mimics the lifelike movement of a wounded prey, thus increasing the anger's ability to encourage a fish to strike the lure. The shape and size of the buoyancy device invention can vary and will determine the type of action the lure is capable of performing. For example, buoyancy device can be fabricated in such a way to favor the movement of the lure in one predominant direction, such as right or left. The invention can also be constructed with the related system to convert the common soft body lure into a diving subsurface lure as seen in FIG. 10. Such diving lip (144) is actually part of the buoyancy device. At the angler's discretion the preferred embodiment may float or dive subsurface. Such dynamic action closely mimics the lifelike movement of a wounded prey, thus increasing the angler's ability to encourage a fish to strike the lure. The embedded hook (146) and stopper (138) will help prevent the lure from flipping over or rotating thereby twisting the fishing line (136).

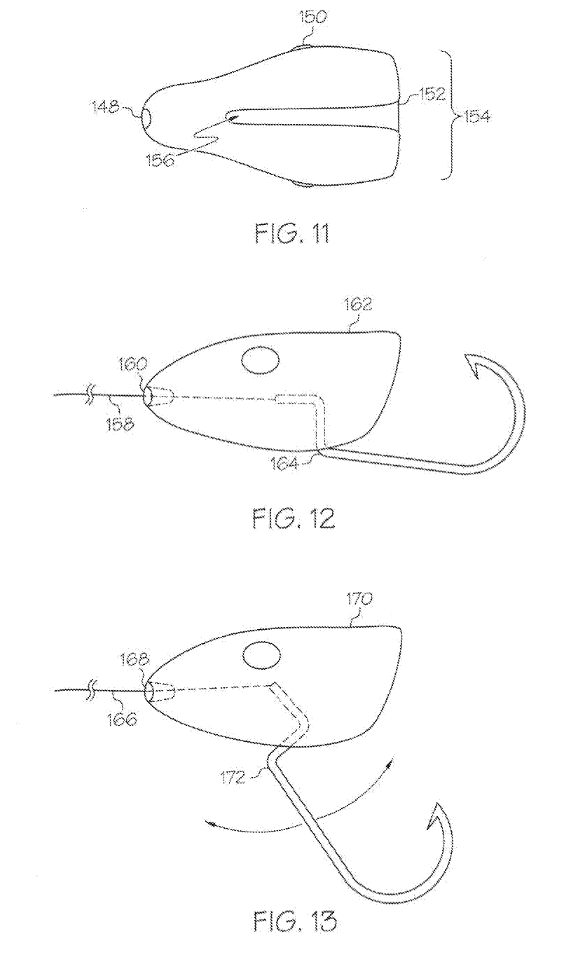

A bottom view of the buoyancy device invention (154) is illustrated in FIG. 11. Such device can be made of any floating material such as, but not limited to, Styrofoam, cork, wood, and plastics. As seen in the diagram, there is an anterior port (148) to receive the rubber stopper device and a narrow hook slot (156) in the ventral cavity to receive the hook shaft. The invention also has a recessed hollow cavity to receive the anterior portion of the soft body lure.

FIG. 12 illustrates the invention and related components joined together. The line (158) passes through the stopper which is embedded in the buoyancy device (160) and tied to the hook (164). In this pictorial one can see the relationship of the hook (164) to the buoyancy device invention (162) hook slot channel in its standard fishing position. Now, in FIG. 13 the effectiveness of the hook slot is clearly illustrated. The hook slot will allow the hook (172) the freedom to swing up and down unencumbered by the buoyancy device (170) while remaining attached to the line that passes through the embedded stopper (168). Such freedom creates a better hook setting ability for the anger as well as, increasing the overall catch by decreasing the ability for the fish to throw the hook. When the fish begins to fight, the hook will be free to move in the channel as the buoyancy device and stopper will begin to slide up the fishing line. An added advantage of the hook slot is to prevent the soft body from twisting in the buoyancy device cavity thereby maintain the proper lure relationship and preventing the lure from flipping as it is retrieved.

1. A fishing lure and related system comprised of a buoyancy device, line stopper, soft body lure, fishing line and hook that when properly joined will materially transform the existing common soft body lure into a materially different lure embodiment than currently existed without its application.

2. The apparatus of claim 1, wherein the invention and related methods are used to change the buoyancy of a soft body fishing lure, or portion of lure body that it is attached to. The invention, when attached, can affect the speed at which a soft body lure rises or falls in the water depending upon the size, shape, and density of the material used in the buoyancy device invention. The buoyancy device can cause the soft body lure to float, slowly sink, or be suspended in the water.

3. The apparatus of claim 1, wherein the invention and related methods are used to change the dynamic movement of the soft body fishing lure or portion of the lure body that it is attached to. The invention when attached can dramatically change the otherwise straight direction movement of a common soft body fishing lure into a side to side or up and down movement depending upon the contours and shapes of the invention. The invention is also capable influencing the movement of the lure into a single dominant direction such as right or left.

4. The apparatus of claim 1, wherein the invention and related methods are used to change the visual appearance of the common soft body fishing lure or portion of the lure body that it is attached to. In most cases, but not exclusively, the invention will change the anterior of a soft body lure into a materially different shape, thereby transforming the lure into a completely different but more realistic appearance. For example, the buoyancy device can present a realistic appearance of anatomical parts such as, but not limited to, gills, scales, eyes, mouth and many other realistic colors and features commonly found with fish.

5. The apparatus of claim 1, wherein the invention and related methods are used to change the structural design of the common soft body fishing lure or portion of the lure body that it is attached to. The invention is structured in such a way that when attached, the fishing hook will not be encumbered by its presence but will rather enhance the overall uniformity and effectiveness of the lure embodiment by shielding the hook on the top (dorsal) and allowing freedom of movement of the hook on the bottom (ventral) inside of the hook slot channel.

6. The apparatus of claim 1, wherein the invention and related methods when attached to a common soft body fishing lure or portion of the soft lure body, can become virtually snag free of both surface and subsurface obstructions by virtue it's deflecting shape. When the hook is embedded in the soft body lure the design of the buoyancy device will allow the lure to move freely between and over obstructions effortlessly.

7. The apparatus of claim 1, wherein the invention and related methods incorporates the unique ability to firmly connect all lure components into a single unit by virtue of the fishing line passing through an additional elastic stopper component, of which is part of the related system. Such stopper is uniquely embedded inside the invention so as not to be seen or encumber the movement of the lure.

8. The apparatus of claim 1, Wherein the invention's hook slot relief channel creates an enhanced hook setting and retention design. Whereas when a fish strikes the new embodiment, the buoyancy device will depress the soft body lure on the top thus allowing the hook to penetrate through the lure much faster and easier, thereby increasing the potential hook set into the fish. Once the fish is hooked then the buoyancy device ventral hook slot relief channel allows the hook to move freely, unencumbered by the device. As the fish begins to fight then the buoyancy device will begin to move up the line. The hook slot also provides anti-twisting capabilities.
